(19) United States
(12) Patent Application Publication
(10) Pub. No.: US 2012/0027331 A1
(43) Pub. Date: Feb. 2, 2012

(54) BEARING ASSEMBLY OF A BLENDER

(76) Inventor: Kai-Fu LIANG, Tucheng (TW)

(21) Appl. No.: 12/843,892

(22) Filed: Jul. 27, 2010

(51) Int. Cl. F16C 33/72

(52) U.S. Cl. 384/477

(57) ABSTRACT

A bearing assembly of a blender consists of a bearing holder (1) having an axial hole (11) and a cavity (12) which connected with said axial hole (11), a shaft (3), a bearing cap (4) provided inside said cavity (12), and two bearings (5a, 5b) provided in said bearing cap (4). Said cavity (12) comprises a first compartment (13) for receiving said bearing cap (4) and a second compartment (14) for receiving a first and a second ring seal (6a, 6b) which are made of Teflon.

### FIELD OF THE INVENTION

The present invention relates to a bearing assembly of a blender.

### DESCRIPTION OF PRIOR ART

The bearing assembly of conventional blender usually includes a watertight structure to avoid liquid penetrating inside the bearing holder, causing element to rust. Such structure can be achieved by installing an elastomeric gasket or washer. However, rubber gasket or washer will become rigid and fragile by aging, reducing its function. Therefore, to find a bearing assembly with an aging proof watertight feature has become the objective of the present invention.

### SUMMARY OF THE INVENTION

To achieve foregoing objective, an improved bearing assembly of a blender consists of a bearing holder (1) having an axial hole (11) and a cavity (12) which connected with said axial hole (1), a shaft (3) passing through said bearing holder (1) with a top end engaged with a blade assembly (2) and a bottom end engaged with a gear (8), a bearing cap (4) provided inside said cavity (12) and two bearings (5a, 5b) are piling up and covered by said bearing cap (12). Said bearing assembly is characterized in that said cavity (12) comprising a first compartment (13) for receiving said bearing cap (4) and a second compartment (14) having one end connected to the first compartment (13), another end connected to said axial hole (11) and is sized for receiving a first and a second ring seal (6a, 6b), which both are axially passed through by the shaft (3). The bottom face of said second ring seal (6b) butts a top face of the bearing cap (4) tightly.

The first and second ring seal (6a, 6b) of the present invention are Teflon washers. Each consists of a thin and elastomeric inner cylinder (61) for engaging with the shaft (3) and a thick and rigid outer cylinder (62). Both cylinders (61, 62) are connected by a thick circular bottom (64). Teflon is a material resistant to high temperature and can endure more than the conventional rubber, achieving longer service life. The features of inner cylinder (61) and outer cylinder (62) allow the ring seals (6a, 6b) can fit perfectly in the second compartment (14).

An elastic ring (63) is added to encircle the outer wall of said inner cylinder (61), and a projection is extended along the circumference of a top end of the inner cylinder (61), forming a stop ring (65) to hold said elastic ring (63). The elastic ring (63) provides contractility to the inner cylinder (61) of the ring seal, allows it to contact with the shaft (3) closely.

Said bearing cap (4) including a neck (44) set on the top, which can fit into a concave (67) set on the bottom of the second ring seal (6b) and pluralities of projections are (41) provided onto the outer wall of said bearing cap (4) in longitudinal fashion and spaced each other equidistantly, forming pluralities channels (43).

The bearing cap (4) is served as a sheath to avoid liquid leaking from the blending jar into the bearing causing corrosion and the channels (43) set on the outer wall can also lead the liquid toward other direction, preventing liquid from entering inside the bearing cap (4).

### BRIEF DESCRIPTION OF DRAWINGS

FIG. 1 is a sectional view of the bearing assembly claimed in the present invention.

FIG. 2 is an exploded view of the bearing assembly.

FIG. 3 is an illustrative view showing the bearing assembly installed in a blender.

FIG. 4 is a sectional view of the bearing assembly with a gasket set between the seal rings.

FIG. 5 is a sectional view of another embodiment of the bearing assembly.

FIG. 6 is an exploded view of FIG. 5.

FIG. 7 is an illustrative view of another embodiment of the bearing assembly.

### DETAILED DESCRIPTION OF PREFERRED EMBODIMENTS OF THE PRESENT INVENTION

The preferred embodiments of the present invention are described in detail according to the appended drawings.

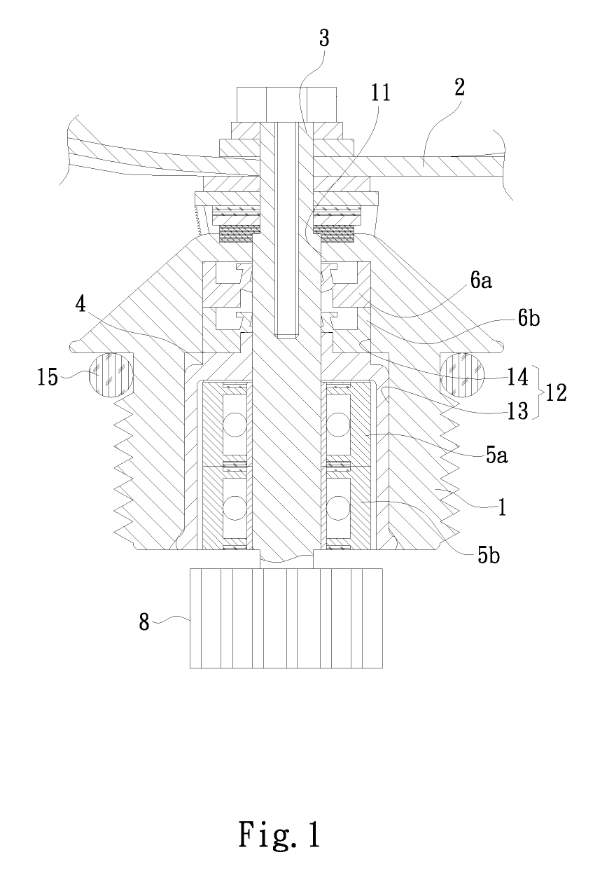

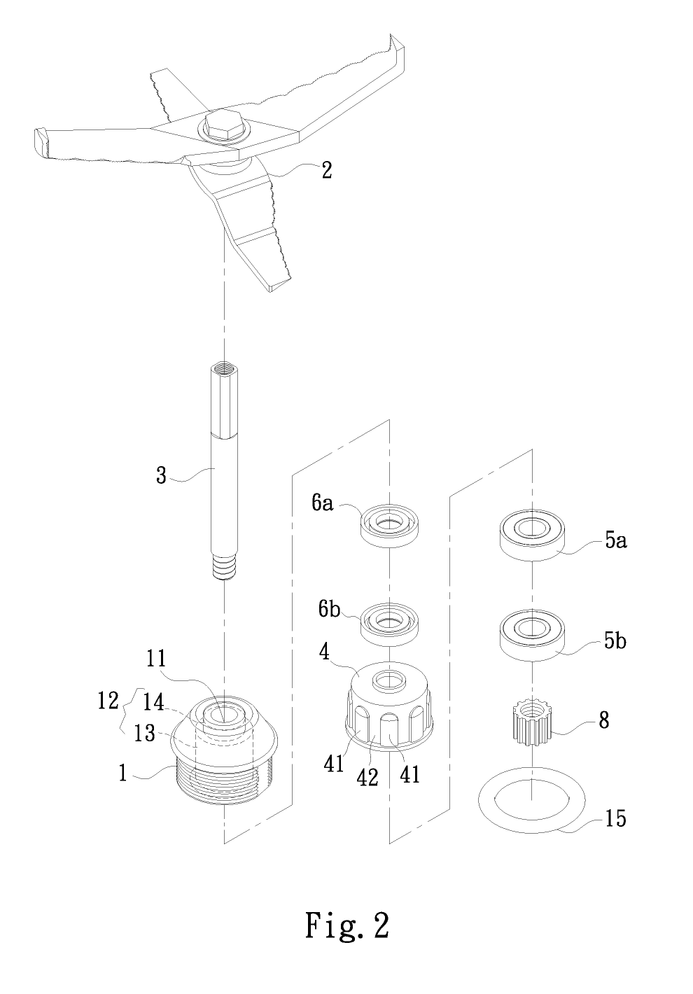

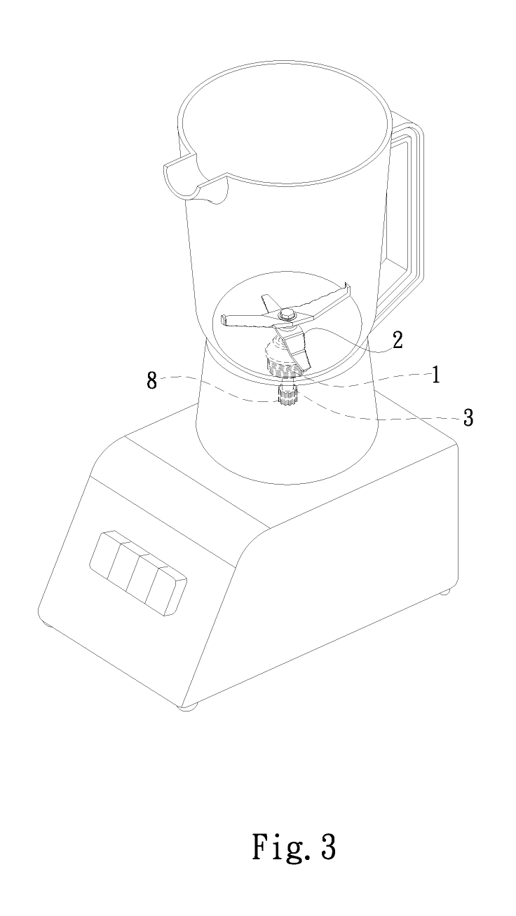

Referring to FIGS. 1 to 3, a bearing assembly of a blender which is placed under a bending jar, consists of a bearing holder (1) having an axial hole (11) and a cavity (12) which connected with said axial hole (11), a shaft (3) passing through said bearing holder (1) with a top end engaged with a blade assembly (2) and a bottom end engaged with a gear (8), a bearing cap (4) provided inside said cavity (12), two bearings (5a, 5b) are piling up and covered by said bearing cap (12) and an rubber 0-ring (15) is provided on the outer wall of the bearing holder (1).

Said bearing assembly is characterized in that said cavity (12) comprising a first compartment (13) for receiving said bearing cap (4) and a second compartment (14) having one end connected to the first compartment (13), another end connected to said axial hole (11) and is sized for receiving a first and second ring seal (6a, 6b), which both are axially passed through by the shaft (3). The bottom face of said second ring seal (6b) butts a top face of the bearing cap (4) tightly.

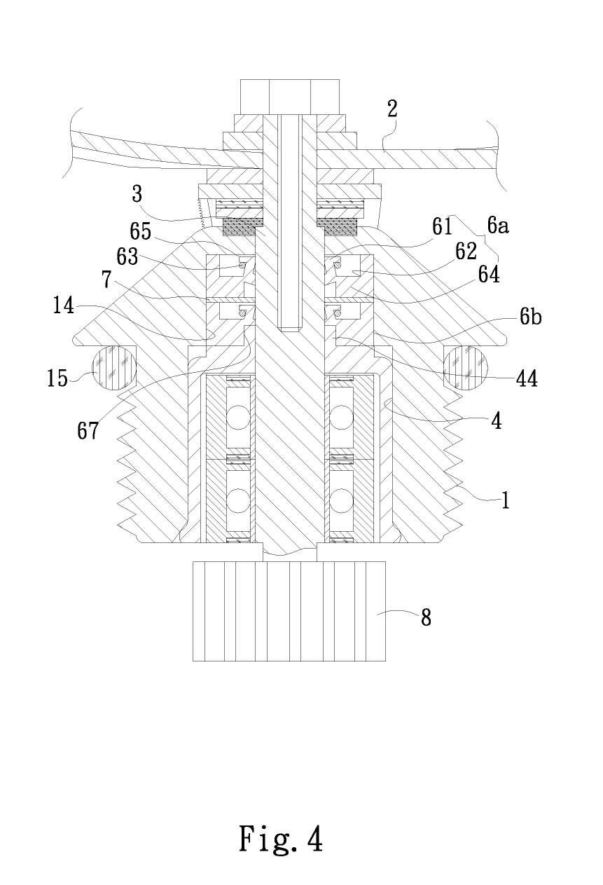

As shown in FIG. 4, the first and second ring seal (6a, 6b) of the present invention are Teflon washers. Each consists of a thin and elastomeric inner cylinder (61) for engaging with the shaft (3) and a thick and rigid outer cylinder (62). Both cylinders (61, 62) are connected by a thick circular bottom (64). The rigid outer cylinder (62) serves as the outer wall of the ring seal for supporting the pressure or load applied thereto. The outer cylinder (62) and inner wall of the second compartment (14) are butting each other tightly to avoid liquid penetrating along the wall of the second compartment (14). The elasticity of said inner cylinder (61) allows it to fit the outer wall of the shaft (3), reduce the damage to the first and second ring seals (6a, 6b) caused by the rotation of the shaft (3). A gasket (7) can be added between piled ring seals (6a, 6b) to avoid the worn out due to the friction.

An elastic ring (63) is added to encircle the outer wall of said inner cylinder (61), and a projection is extended along the circumference of a top end of the inner cylinder (61), forming a stop ring (65) to hold said elastic ring (63). The elastic ring (63) provides contractility to the inner cylinder (61) of the ring seal, allows it to couple with the shaft (3) tightly.

Said bearing cap (4) including a neck (44) set on the top which fits into a concave (67) set on the bottom of the second ring seal (6b) to provide a better sealing and to fix the position of said ring seal (6b).

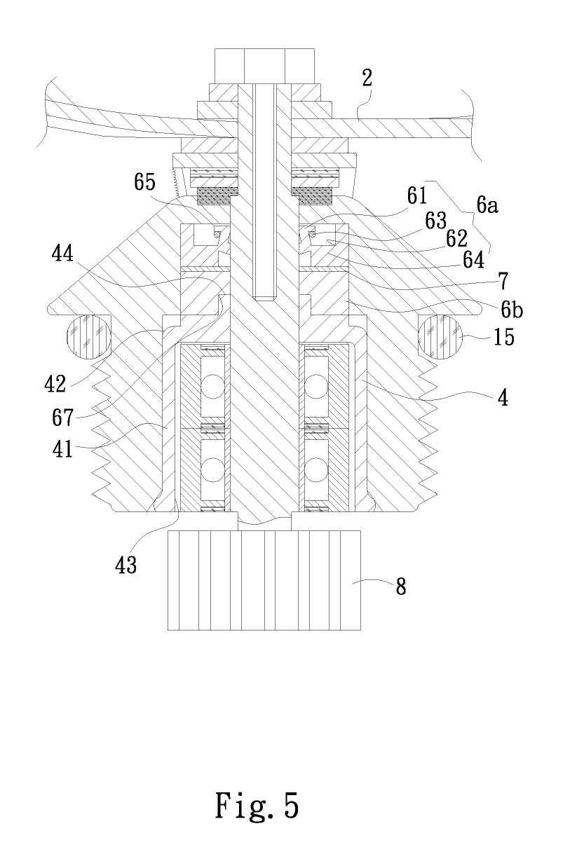

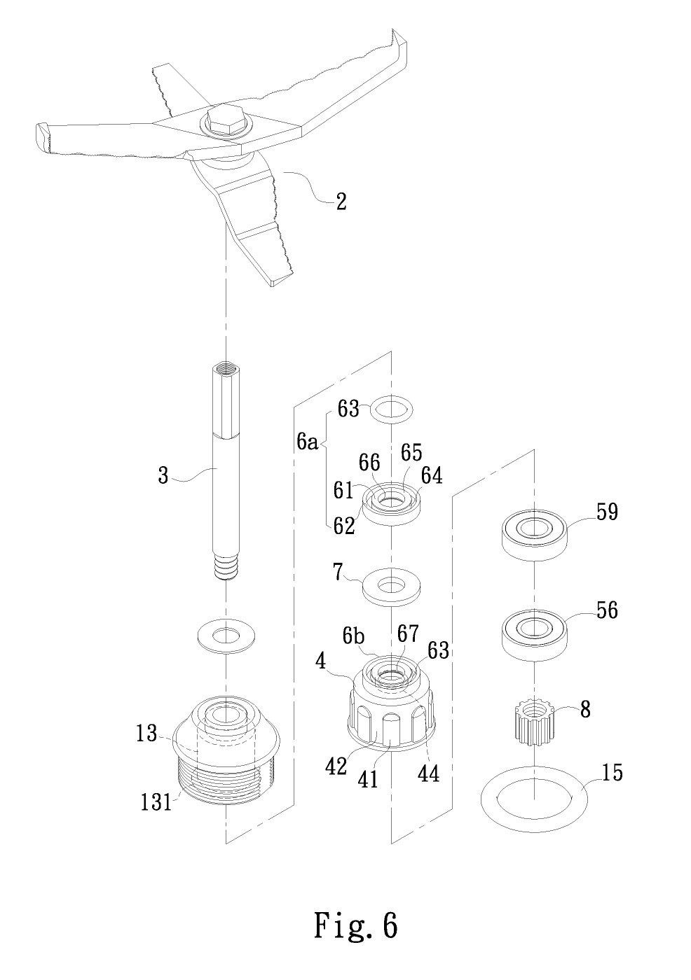

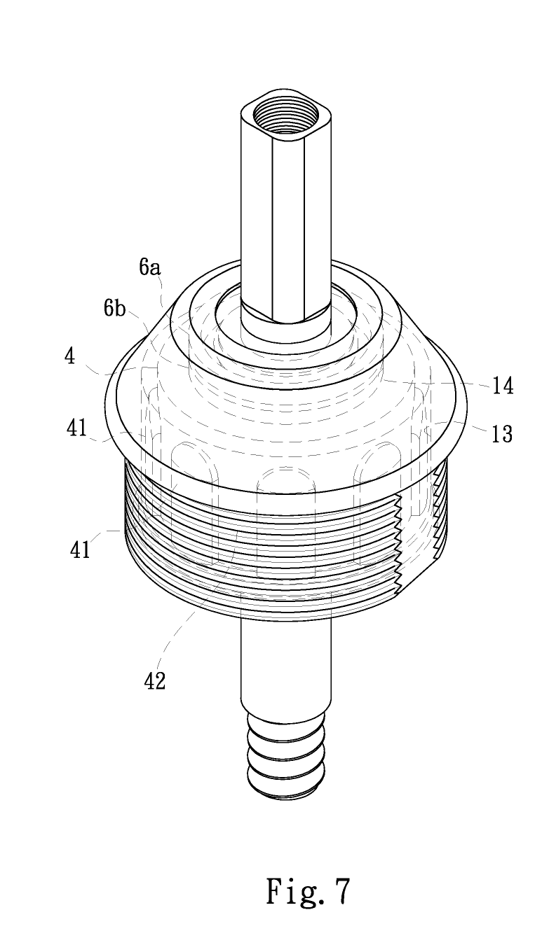

FIGS. 5 to 7 demonstrate another embodiment of the claimed bearing assembly, wherein the bottom of the second ring seal (6b) is coupled to the top of said bearing cap (4) by adhesive or high frequency wave to improve the sealing.

Moreover, pluralities of projections are (41) provided onto the outer wall of said bearing cap (4) in longitudinal fashion and spaced from each other equidistantly, forming pluralities of channels (43). The bearing cap (4) is served as a sheath to avoid liquid leaking from the blending jar into the bearing causing corrosion. The channels (43) set on the outer wall can also lead the liquid toward other direction, preventing liquid from entering inside the bearing cap (4).

1. A bearing assembly of a blender comprising:
a bearing holder (1) having an axial hole (11) and a cavity (12) which connected with said axial hole (11);
a shaft (3) passed through said bearing holder (1) with a top end thereof engaged with a blade assembly (2) and a bottom end engaged with a gear (8);
a bearing cap (4) provided inside said cavity (12) and two bearings (5a, 5b) are piling up and covered by said bearing cap (12);
characterized in that:
said cavity (12) comprising a first compartment (13) for receiving said bearing cap (4) and a second compartment (14) having one end connected with the first compartment (13), another end connected with said axial hole (11) and is sized for receiving a first and a second ring seal (6a, 6b), which both are axially passed through by the shaft (3).

2. The bearing assembly of a blender of claim 1, wherein a bottom end of said second ring seal (6b) butts a top face of the bearing cap (4) tightly.

3. The bearing assembly of a blender of claim 1, wherein said first and second ring seals (6a, 6b) are Teflon washers; each consists of a thin and elastomeric inner cylinder (61) for receiving the shaft (3) and a thick and rigid outer cylinder (62); both cylinders (61, 62) are connected by a thick circular bottom (64).

4. The bearing assembly of a blender of claim 3, wherein an elastic ring (63) encircles an outer wall of said inner cylinder (61) and a projection is extended along a circumference of a top end of the inner cylinder (61), forming a stop ring to hold said elastic ring (63).

5. The bearing assembly of a blender of claim 3, wherein said bearing cap (4) including a neck (44) set on the top and said neck (44) fits into a concave (67) set on the bottom of the second ring seal (6b).

6. The bearing assembly of a blender of claim 3, wherein a plurality of projections are (41) provided onto an outer wall of said bearing cap (4) in longitudinal and equidistant fashion, forming pluralities channels (43).
